(19) United States
(12) Patent Application Publication
(10) Pub. No.: US 2022/0253701 A1
(43) Pub. Date: Aug. 11, 2022

(54) LEARNING DEVICE, INFERENCE DEVICE, LEARNING METHOD, INFERENCE METHOD, AND LEARNING PROGRAM

(71) Applicant: NIPPON TELEGRAPH AND TELEPHONE CORPORATION, Tokyo (JP)

(72) Inventors: Hidetaka ITO, Tokyo (JP); Tatsushi MATSUBAYASHI, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/628,485

(22) PCT Filed: Jul. 22, 2019
(86) PCT No.: PCT/JP2019/028684

§ 371 Date: Jan. 19, 2022

(51) Int. Cl. G06N 3/08

(52) U.S. Cl. CPC G06N 3/08

(57) ABSTRACT

In a learning apparatus, in a neural network into which low-resolution data having a low resolution and representing demographics including positions and densities, first auxiliary information related to types of locations in an area and positions of the locations, and second auxiliary information representing at least one of a time of day, weather, or another information representing a change in time series are input, and from which resolution enhanced data with resolution of the demographics being enhanced is output, resolution enhanced intermediate data with a resolution of the low-resolution data for learning for each set of an area and a time zone being enhanced is determined, weights for the types of locations using the first auxiliary information for the types of locations and the second auxiliary information, for each set of an area and a time zone is determined, resolution enhanced data that is the first auxiliary information weighted by the weight for each of the types of locations being integrated with the resolution enhanced intermediate data is output, and parameters of the neural network are learned based on the resolution enhanced data output from the neural network and high-resolution data for the learning for each set of an area and a time zone.

### TECHNICAL FIELD

The disclosed techniques relate to a learning apparatus, an inference apparatus, a learning method, an inference method, and a learning program.

### BACKGROUND ART

Analysis of communication statuses of mobile phones or the like can give demographics at a certain time, that is, how many people are in a certain region at a certain time. The use of demographic data allows for the delivery of advertisements to a region with many people.

Resolution enhancement may be required in the use of demographic data.

In recent years, the development of deep neural networks (DNNs) has proposed an image resolution enhancement technique for outputting a high-resolution image from a low-resolution image by using a DNN model (NPL 1).

### CITATION LIST

### Non Patent Literature

NPL 1: Dong, C., Loy, C. C., He, K., & Tang, X. (2016). Image super-resolution using deep convolutional networks. IEEE transactions on pattern analysis and machine intelligence, 38(2), 295-307.

### SUMMARY OF THE INVENTION

### Technical Problem

However, even if the image resolution enhancement technique is applied to demographics as is, this does not result in sufficient resolution enhancement.

The present disclosure aims at providing a learning apparatus, an inference apparatus, a learning method, an inference method, and a learning program for enhancing resolution of demographics to reflect human behavioral patterns.

### Means for Solving the Problem

A first aspect of the present disclosure is a learning apparatus including a learning unit configured to, in a neural network into which low-resolution data having a low resolution and representing demographics including positions and densities, first auxiliary information related to a type of location in an area and a position of the location, and second auxiliary information representing at least one of a time of day, weather, or another information representing a change in time series are input, and from which resolution enhanced data that is the demographics whose resolution being enhanced is output, determine, based on the low-resolution data for learning for a set of an area and a time zone, resolution enhanced intermediate data that is the low-resolution data for the learning whose resolution being enhanced, determine a weight for the type of location using the first auxiliary information for the type of location and the second auxiliary information, for the set of the area and the time zone, output resolution enhanced data that is the first auxiliary information weighted by the weight for the type of location being integrated with the resolution enhanced intermediate data, and learn a parameter of the neural network, based on the resolution enhanced data output from the neural network and high-resolution data having a high resolution and representing the demographics for learning for the set of the area and the time zone.

A second aspect of the present disclosure is an inference apparatus including an inference unit configured to input, into a neural network learned in advance to receive an input of low-resolution data having a low resolution and representing demographics including positions and densities, first auxiliary information related to a type of location in an area and a position of the location, and second auxiliary information representing at least one of a time of day, weather, or another information representing a change in time series and to output resolution enhanced data with resolution of the demographics being enhanced, the low-resolution data as a target, and the first auxiliary information and the second auxiliary information for the low-resolution data as the target, and output, as an output from the neural network, the resolution enhanced data that is the demographics of the low-resolution data as the target whose resolution being enhanced, in which the neural network determines, based on the low-resolution data for learning for a set of an area and a time zone, resolution enhanced intermediate data that is the low-resolution data for the learning whose resolution being enhanced, determines a weight for the type of location using the first auxiliary information for the type of location and the second auxiliary information, for the set of the area and the time zone, and outputs resolution enhanced data that is the first auxiliary information weighted by the weight for the type of location being integrated with the resolution enhanced intermediate data, and a parameter of the neural network is learned based on the resolution enhanced data output from the neural network and high-resolution data having a high resolution and representing the demographics for learning for the set of the area and the time zone.

A third aspect of the present disclosure is a learning method causing a computer to execute processing including, in a neural network into which low-resolution data having a low resolution and representing demographics including positions and densities, first auxiliary information related to a type of location in an area and a position of the location, and second auxiliary information representing at least one of a time of day, weather, or another information representing a change in time series are input, and from which resolution enhanced data that is the demographics whose resolution being enhanced is output, determining, based on the low-resolution data for learning for a set of an area and a time zone, resolution enhanced intermediate data that is the low-resolution data for the learning whose resolution being enhanced, determining a weight for the type of location using the first auxiliary information for the type of location and the second auxiliary information, for the set of the area and the time zone, outputting resolution enhanced data that is the first auxiliary information weighted by the weight for the type of location being integrated with the resolution enhanced intermediate data, and learning a parameter of the neural network, based on the resolution enhanced data output from the neural network and high-resolution data having a high resolution and representing the demographics for learning for the set of the area and the time zone.

A fourth aspect of the present disclosure is an inference method causing a computer to execute processing including inputting, into a neural network learned in advance to receive an input of low-resolution data having a low resolution and representing demographics including positions and densities, first auxiliary information related to a type of location in an area and a position of the location, and second auxiliary information representing at least one of a time of day, weather, or another information representing a change in time series and to output resolution enhanced data that is the demographics whose resolution being enhanced, the low-resolution data as a target, and the first auxiliary information and the second auxiliary information for the low-resolution data as the target, and outputting, as an output from the neural network, the resolution enhanced data that is the demographics of the low-resolution data as the target whose resolution being enhanced, in which the neural network determines, based on the low-resolution data for learning for a set of an area and a time zone, resolution enhanced intermediate data that is the low-resolution data for the learning whose resolution being enhanced, determines a weight for the type of location using the first auxiliary information for the type of location and the second auxiliary information, for the set of the area and the time zone, and outputs resolution enhanced data that is the first auxiliary information weighted by the weight for the type of location being integrated with the resolution enhanced intermediate data, and a parameter of the neural network is learned based on the resolution enhanced data output from the neural network and high-resolution data having a high resolution and representing the demographics for learning for the set of the area and the time zone.

A fifth aspect of the present disclosures is a learning program causing a computer to execute, in a neural network into which low-resolution data having a low resolution and representing demographics including positions and densities, first auxiliary information related to a type of location in an area and a position of the location, and second auxiliary information representing at least one of a time of day, weather, or another information representing a change in time series are input, and from which resolution enhanced data that is the demographics whose resolution being enhanced is output, determining, based on the low-resolution data for learning for a set of an area and a time zone, resolution enhanced intermediate data that is the low-resolution data for the learning whose resolution being enhanced, determining a weight for the type of location using the first auxiliary information for the type of location and the second auxiliary information, for the set of the area and the time zone, outputting resolution enhanced data that is the first auxiliary information weighted by the weight for the type of location being integrated with the resolution enhanced intermediate data, and learning a parameter of the neural network, based on the resolution enhanced data output from the neural network and high-resolution data having a high resolution and representing the demographics for learning for the set of the area and the time zone.

### Effects of the Invention

According to the disclosed technique, the resolution of the demographics can be enhanced to reflect human behavioral patterns.

### BRIEF DESCRIPTION OF DRAWINGS

FIG. 1 is a diagram illustrating an image of input to a DNN model and output of resolution enhanced data.

FIG. 2 is a block diagram illustrating a configuration of a learning apparatus according to the present embodiment.

FIG. 3 is a block diagram illustrating a hardware configuration of the learning apparatus and a forecast apparatus.

FIG. 4 is a diagram illustrating an example of information stored in a demographics accumulation unit.

FIG. 5 is a diagram illustrating an example of information stored in a first auxiliary information accumulation unit.

FIG. 6 is a diagram illustrating an example of information stored in a second auxiliary information accumulation unit.

FIG. 7 is a diagram illustrating an example of the DNN model.

FIG. 8 is a diagram illustrating an image of preserving a population density in resolution enhancement by a resolution enhancement layer.

FIG. 9 is a flowchart illustrating a sequence of learning processing performed by the learning apparatus.

FIG. 10 is a block diagram illustrating a configuration of an inference apparatus according to the present embodiment.

FIG. 11 is a flowchart illustrating a sequence of inference processing performed by the inference apparatus.

### DESCRIPTION OF EMBODIMENTS

Hereinafter, one example of the embodiments of the disclosed technique will be described with reference to the drawings. In the drawings, the same reference numerals are given to the same or equivalent constituent elements and parts. Dimensional ratios in the drawings are exaggerated for the convenience of description and thus may differ from actual ratios.

First, a premise and summary of the present disclosure will be described.

An approach of the present embodiment is directed to resolution enhancement of demographics. Demographics may result in spatial resolution differences depending on a time of day and a region. For example, as an example of the spatial resolution differences depending on a region, high-resolution demographic data can be obtained in regions where the number of base stations is large, but may not be obtained in regions where the number of base stations is small. Therefore, there is a need for techniques for enhancing the resolution of the demographics, such as by inputting data of a region that only yields low-resolution demographics to a learned model to output high-resolution demographics. For the model, it is necessary to learn a model by using data of the demographics of the region yielding the high-resolution demographics and another auxiliary information.

In recent years, the development of deep neural networks (DNNs) has proposed an image resolution enhancement technique for outputting a high-resolution image from a low-resolution image by using a DNN model (NPL 1). In this approach, a pair of low-resolution and high-resolution images is used to learn the model of DNN. That is, using the low-resolution image as input, a calculation of a DNN model is performed to output an inferred high-resolution image, and parameters for the DNN model are determined so that a difference between the output result and a correct high-resolution image is reduced.

Demographics can be considered as data having a format similar to that of an image by identifying a population in a certain location with pixels of the image. Thus, using such a DNN model, it is also possible to enhance the resolution of demographics rather than images.

However, the resolution enhancement of demographics requires consideration of the following points, which are not considered for image resolution enhancement. The first point is that demographics meets population preservation. For example, if there are a thousand people in an area, even if the area is divided into four areas, the sum of the populations of the divided areas is preserved as a thousand. The second point is that the population depends on auxiliary information such as the numbers of homes and offices. People are prone to gather in the homes or the offices, and a region with many homes or offices is likely to be populous. For the second point, a case needs to be considered also in which a relationship between the population and the auxiliary information such as the numbers of homes and offices varies depending on a day of the week, a time of day, and weather. For example, from morning to evening, people gather in offices, so people gather in locations where the number of offices is large. On the other hand, at night, people gather in homes, so people gather in locations where the number of homes is large. In this way, human behavioral patterns are reflected in the population density at each location at each time.

Therefore, in the present embodiment, the resolution enhancement of demographics using a DNN model in consideration of the above points is proposed. Hereinafter, in the present disclosure, low-resolution demographic data and high-resolution demographic data of demographic data representing demographics including positions and densities are expressed as low-resolution data and high-resolution data, respectively. Similarly, the demographic data enhanced in the resolution is expressed as resolution enhanced data.

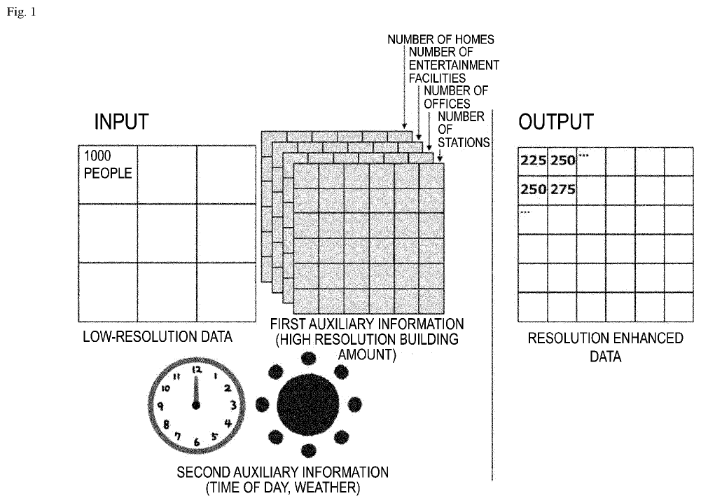

The resolution enhancement of demographics in the present disclosure uses, as input for a DNN model, low-resolution data, first auxiliary information that includes types of locations such as the number of homes and the number of offices, and positions of the locations, and second auxiliary information that includes a time of day and weather. FIG. 1 is a diagram illustrating an image of input to the DNN model and output of resolution enhanced data. As illustrated in FIG. 1, the DNN model outputs resolution enhanced data that represents demographics and is enhanced in resolution in response to the input.

The resolution enhancement of the demographics is achieved through a learning phase by a learning apparatus and an inference phase by an inference apparatus. In the learning phase, parameters for the DNN model are learned using the input of the low-resolution data, the first auxiliary information, and the second auxiliary information, and high-resolution data that is correct answer information. In the inference phase, high-resolution demographic data is inferred using the low-resolution data, the first auxiliary information, and the second auxiliary information, and is output.

The DNN model has a mechanism to first enhance the resolution of the low-resolution data. At this time, a portion of the high-resolution data is calculated from the low-resolution data and other high-resolution data to preserve the sum of populations for resolution enhanced intermediate data corresponding to the low-resolution data.

The DNN model also has a mechanism to use the first auxiliary information and the second auxiliary information to perform weighting according to which first auxiliary information should be prioritized. Furthermore, the DNN model changes the priorities of the first auxiliary information in accordance with the weighting. The weighting reflects human behavioral patterns.

The DNN model has a mechanism to adjust the resolution enhanced data by using the weighted first auxiliary information. The DNN model finally outputs the adjusted resolution enhanced data.

A configuration in the present embodiment will be described below.

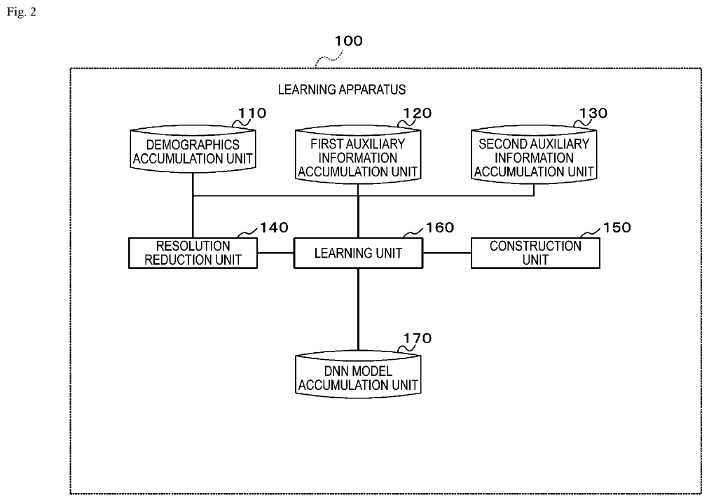

Configuration and Effect of Learning Apparatus FIG. 2 is a block diagram illustrating a configuration of the learning apparatus according to the present embodiment.

As illustrated in FIG. 2, a learning apparatus 100 includes a demographics accumulation unit 110, a first auxiliary information accumulation unit 120, a second auxiliary information accumulation unit 130, a resolution reduction unit 140, a construction unit 150, a learning unit 160, and a DNN model accumulation unit 170.

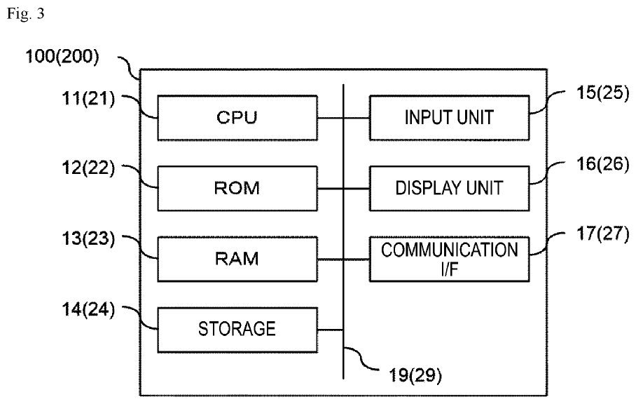

FIG. 3 is a block diagram illustrating a hardware configuration of the learning apparatus 100.

As illustrated in FIG. 3, the learning apparatus 100 includes a central processing unit (CPU) 11, a read only memory (ROM) 12, a random access memory (RAM) 13, a storage 14, an input unit 15, a display unit 16, and a communication interface (I/F) 17. The components are communicably interconnected through a bus 19.

The CPU 11 is a central processing unit that executes various programs and controls each unit. In other words, the CPU 11 reads a program from the ROM 12 or the storage 14 and executes the program using the RAM 13 as a work area. The CPU 11 performs control of each of the components described above and various arithmetic processing operations in accordance with a program stored in the ROM 12 or the storage 14. In the present embodiment, a learning program is stored in the ROM 12 or the storage 14.

The ROM 12 stores therein various programs and various kinds of data. The RAM 13 is a work area that temporarily stores a program or data. The storage 14 is constituted by a hard disk drive (HDD) or a solid state drive (SSD) and stores various programs including an operating system and various kinds of data.

The input unit 15 includes a pointing device such as a mouse, and a keyboard and is used for performing various inputs.

The display unit 16 is, for example, a liquid crystal display and displays various kinds of information. The display unit 16 may employ a touch panel system and function as the input unit 15.

The communication interface 17 is an interface for communicating with other devices such as terminals and, for example, uses a standard such as Ethernet (trade name), FDDI, or Wi-Fi (trade name).

Next, each functional configuration of the learning apparatus 100 will be described. Each functional configuration is implemented by the CPU 11 reading a learning program stored in the ROM 12 or the storage 14, and loading the learning program into the RAM 13 to execute the program.

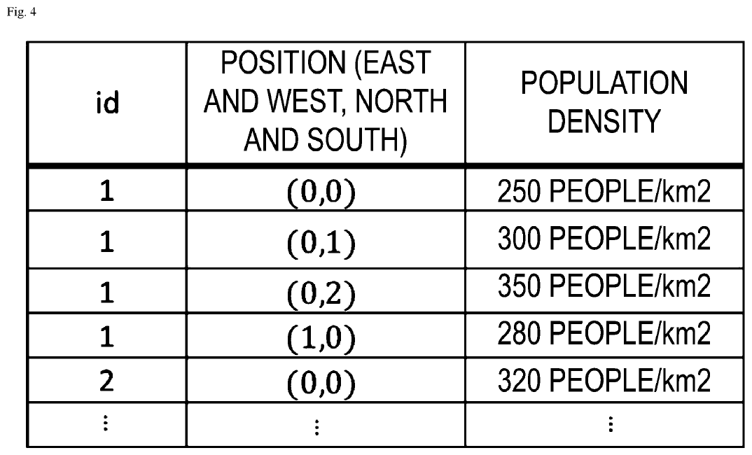

Demographic data of a plurality of areas or time zones is accumulated in the demographics accumulation unit 110, the demographic data being linked to an id to distinguish the data. The demographic data accumulated in the demographics accumulation unit 110 is high-resolution data for learning. The demographic data linked to each id is demographic data of one area in one time zone, and the id represents a set of the area and the time zone. The area is comprised of a plurality of locations (cells), and the resolution of the demographic data is determined depending on the size of the cells. An extent of the area is assumed to be uniform. The demographic data is assumed as data obtained by dividing the area targeted by the demographic data into meshes, and recording, for each mesh cell, a population density within the mesh cell. The data may be that obtained by processing the population density by normalization or the like. At this time, the mesh cell indicates the size of one cell of the demographic data, and a 1 km mesh indicates that a 1 km square is one cell. The size of the mesh cell is not limited, and it is also possible to use a rectangular cell rather than a square cell. In the following, the cell is assumed to be square. FIG. 4 is a diagram illustrating an example of information stored in the demographics accumulation unit 110. The position (east and west, north and south) in one example of FIG. 4 is represented as a two-dimensional vector. The representation of this vector will be described. A range of one mesh from the westernmost and southernmost point in the targeted area is expressed as (0, 0). The position is represented by a vector of which the first element is incremented by one every time one mesh cell is displaced from (0, 0) to east, and the second element is incremented by one every time one mesh cell is displaced to north.

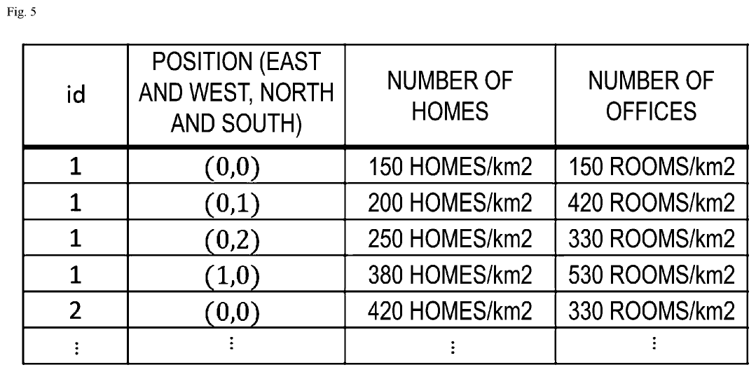

First auxiliary information, which is linked to an id to distinguish the data, of a plurality of areas and time zones is accumulated in the first auxiliary information accumulation unit 120. Examples of the first auxiliary information include the number of homes, the number of offices, the number of amusement facilities, the number of stations, the number of roads, or areas thereof. The data may be that obtained by processing the first auxiliary information by normalization or the like. The number of types of the first auxiliary information is n. Here, the first auxiliary information is assumed as data obtained, similarly to the demographic data, by dividing the area targeted by the data into meshes, and recording, for each mesh cell, first auxiliary information within the mesh cell. The id of the data corresponds to data stored in the demographics accumulation unit 110, and the extent of the area targeted by the data and the size of the mesh cell are also the same as those of the data stored in the demographics accumulation unit 110. The data described above exists for each of n types of first auxiliary information. The data are expressed as sᵢ, . . . , sₙ. sᵢ (i=1, n) represents the data in which one certain type of first auxiliary information is recorded for every mesh cell in the area. The type of location in the area is a home, an office, a facility, a station, a road, etc. For example, a home is assigned with i=1, and an office is assigned with i=2. A plurality of pieces of the first auxiliary information are accumulated in the first auxiliary information accumulation unit 120. FIG. 5 is a diagram illustrating an example of information stored in the first auxiliary information accumulation unit 120. FIG. 5 illustrates an example in a case that the number of homes and the number of offices at each position (east and west, north and south) are stored as the first auxiliary information.

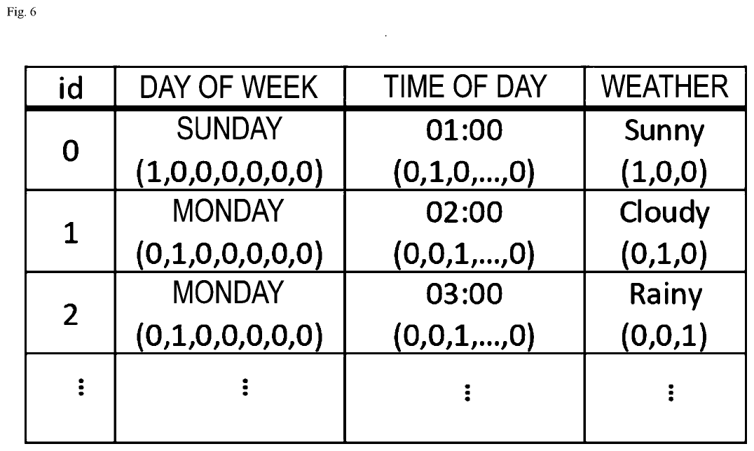

Second auxiliary information, which is linked to an id to distinguish the data, is accumulated in the second auxiliary information accumulation unit 130. Examples of the second auxiliary information include elements of a day of the week, a time of day, and weather. Here, the second auxiliary information is data in which each element has one value for one id. Examples of a data format of the second auxiliary information include a one-hot vector format in which only a certain element has a value of 1, and other elements have a value of 0. A vector obtained by coupling all pieces of the second auxiliary information is represented by t. FIG. 6 is a diagram illustrating an example of information stored in the second auxiliary information accumulation unit 130. In FIG. 6, both an expression by the one-hot vector format and the meaning of the expression by the natural language are indicated. Note that any information other than the above may be used for the elements of the second auxiliary information as long as the information represents a change in time series.

In each of the following processing operations by the units, the id is designated as 1, . . . , and N, the size of a mesh cell of low-resolution data is designated as m, the extent of an area in data linked to one id is designated as dm, and the size of a mesh cell of high-resolution data is designated as m/r. At this time, the low-resolution data is defined as d×d sections and is data in which the area is divided vertically into d and horizontally into d and the population densities are preserved. The high-resolution data is data in which the population densities of rd×rd sections are preserved. The first auxiliary information is also data in which auxiliary information for rd×rd sections is preserved. Examples of m, r, and d are 1000 (meters), 2(-fold), and 100 (divisions), respectively. Thus, m represents the size of locations (cells) in the area, r represents a multiple number of the resolution enhancement, and d represents the number of divisions with reference to the low resolution.

The resolution reduction unit 140 acquires high-resolution data accumulated in the demographics accumulation unit 110, creates low-resolution data that is the high-resolution data whose resolution is reduced, and outputs the low-resolution data to the learning unit 160. The resolution reduction unit 140 averages the population density data in a set of r×r mesh cells of the high-resolution demographic data, and performs processing to generate one piece of low-resolution demographic data in a set of d×d mesh cells. The low-resolution data output from the resolution reduction unit 140 is an example of the low-resolution data for learning for each set of the area and the time zone.

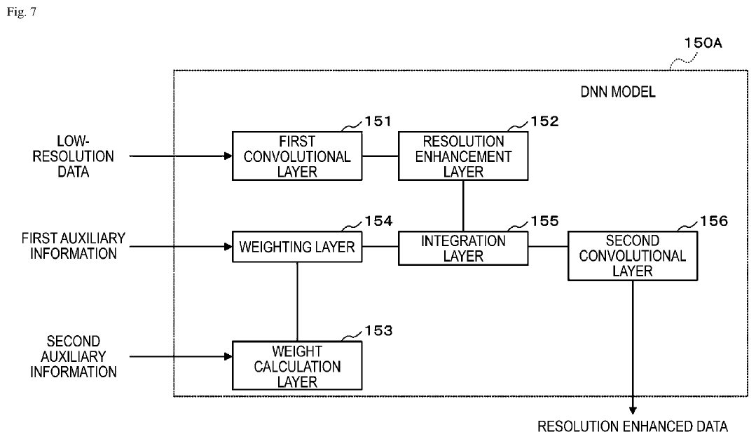

The construction unit 150 constructs a DNN model as a neural network for enhancing the resolution of the demographics and outputs the constructed model to the learning unit 160. FIG. 7 is a diagram illustrating an example of the DNN model. Hereinafter, the DNN model that performs learning processing in the present embodiment will be described with reference to FIG. 7.

As illustrated in FIG. 7, the DNN model constructed in the present embodiment is a DNN model 150A. Each layer of the DNN model 150A includes a first convolutional layer 151, a resolution enhancement layer 152, a weight calculation layer 153, a weighting layer 154, an integration layer 155, and a second convolutional layer 156. Here, an input to the first convolutional layer 151 is low-resolution data. An input to the weight calculation layer 153 is the first auxiliary information and the second auxiliary information. In other words, in the DNN model 150A constructed in the construction unit 150, the input includes the low-resolution data, the first auxiliary information, and the second auxiliary information. The processing performed in each layer will be described below.

The first convolutional layer 151 processes the low-resolution data using a convolutional neural network (CNN). The convolutional neural network is constructed in a plurality of iterated operations of processing to convolve demographic data with a 3×3 filter, normalization processing, and the like, for example. The convolution processing with the 3×3 filter is processing in which input for a certain position (x, y) is population density data of respective positions, a weighted linear sum of the input data is calculated, and the calculated weighted linear is output for the position (x, y). The respective positions are (x−1, y−1), (x−1, y), (x−1, y+1), (x, y−1), (x, y), (x, y+1), (x+1, y−1), (x+1, y), and (x+1, y+1). The weight of the weighted linear sum is optimized in the learning unit 160 as a parameter for the neural network. Reference is made to NPL 1 for the convolutional neural network. The convolutional layer may be any neural network as long as the neural network can generate r²−1 pieces of data having d×d mesh cells as the final output.

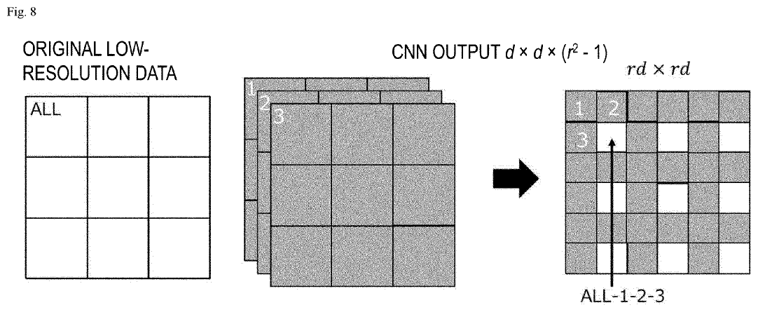

The resolution enhancement layer 152 determines resolution enhanced intermediate data that is the low-resolution data, which is output from the first convolutional layer 151, whose resolution is enhanced and outputs the resolution enhanced intermediate data to the integration layer 155. At this time, r²−1 pieces of data having d×d mesh cells output by the first convolutional layer 151 are used to generate the resolution enhanced intermediate data having rd×rd mesh cells. A method for enhancing the resolution will be described. The following processing operations are performed on all cells of the low-resolution data. One cell of the low-resolution data corresponds to r×r cells of the high-resolution data. Here, because the number of pieces of high-resolution data is r²−1 for one cell of the low-resolution data, r²−1 pieces of data are arranged in order in r²−1 cells of r×r cells. Then, for the remaining one cell, a population density value of the corresponding cell of the original low-resolution data prior to the processing performed in the first convolutional layer 151 is extracted. Then, a value obtained by subtracting the sum of the population density values of r²−1 pieces of data from the extracted population density value is arranged for the remaining one cell. This process preserves the population sum because the sum of the values of the population densities of r×r cells equals the value of the corresponding cell of the original low-resolution demographic data. FIG. 8 is a diagram illustrating an image of preserving the population density in the resolution enhancement by the resolution enhancement layer 152. As illustrated in FIG. 8, the resolution enhanced intermediate data that preserves the population densities of the original low-resolution data contributes to improved stability of the learning processing. As described above, the resolution enhancement layer 152 determines, in the learning processing, based on the low-resolution data for learning for each set of the area and the time zone, the resolution enhanced intermediate data that is the low-resolution data for learning whose resolution is enhanced.

The weight calculation layer 153 determines a weight αᵢ (i=1, n) for each of n types of locations using the first auxiliary information for n types of locations and the second auxiliary information. The weight for which information is utilized on a priority basis among the first auxiliary information sᵢ is calculated from the first auxiliary information and the second auxiliary information. In other words, the weights α₁, . . . , αₙ of the respective priorities of the first auxiliary information are calculated. The weight calculation method may be any technique, and as an example, a method for calculating a weight using a mechanism similar to that of an attention mechanism is used. Reference is made to Reference Document 1 for the attention mechanism. Reference Document 1: Xu, K., Ba, J., Kiros, R., Cho, K., Courville, A., Salakhudinov, R., . . . & Bengio, Y. (2015, June). Show, attend and tell: Neural image caption generation with visual attention. In International conference on machine learning (pp. 2048-2057). However, note that the calculation of only one weight for one auxiliary information piece in the present disclosure is different from the calculation method of the attention in Reference Document 1. In a case of using the attention mechanism in the present disclosure, the weight αᵢ is calculated using a score function S(x, y) as expressed in Equation (1) below.

$$\begin{matrix}[ Math . 1 ] & \\ {α}_{i} = \frac{exp ( S ( {s}_{i} , t ) )}{{\sum }_{j = 1}^{n} exp ( S ( {s}_{j} , t ) )} & ( 1 )\end{matrix}$$

Here, note that the first auxiliary information is denoted as s₁, . . . , sₙ, and the second auxiliary information is denoted as t. Examples of the score function S(x, y) includes Equation (2) below.

$$\begin{matrix}[ Math . 2 ] & \\ {α}_{i} = \frac{exp ( S ( {s}_{i} , t ) )}{{\sum }_{j = 1}^{n} exp ( S ( {s}_{j} , t ) )} & ( 2 )\end{matrix}$$

Here, v, Wₓ, and W_{y} are parameters for the neural network of the weight calculation layer 153, and are optimized by the learning unit 160. Examples of the neural network includes a multilayer perceptron. The multilayer perceptron is constructed by a plurality of iterated operations of processing for calculating and outputting a plurality of weighted averages of inputs. As described above, the weight calculation layer 153 determines, in the learning processing, the weights for the types of locations using the first auxiliary information for the types of locations and the second auxiliary information, for each set of the area and the time zone.

The weighting layer 154 outputs the first auxiliary information weighted for each type of location, which is obtained by weighting the weights αᵢ for n types of locations to the first auxiliary information sᵢ for n types of locations, to the integration layer 155. The first auxiliary information s₁, . . . , sₙ is multiplied by the weights α₁, . . . , αₙ of the priorities obtained in the weight calculation layer 153. That is, the weighting layer 154 outputs the first auxiliary information weighted s′₁, . . . , s′ₙ obtained by replacing all elements s_{i,j} of sᵢ with s_{i,j}αᵢ. Thus, the weight αᵢ for the first auxiliary information sᵢ is the same in all the cells. By the weight it is possible to consider which type of location is prioritized. As described above, the weighting layer 154 determines, in the learning processing, the first auxiliary information weighted for each type of location.

The integration layer 155 outputs n+1 types of data corresponding to the types of locations, which is the result of integrating the first auxiliary information weighted for each type of location weighted by the weighting layer 154 and the resolution enhanced intermediate data enhanced in the resolution by the resolution enhancement layer 152. Both the first auxiliary information weighted and the resolution enhanced intermediate data are data having a size of rd×rd, and the first auxiliary information weighted includes n types of data and the resolution enhanced intermediate data includes one type of data, and thus, n+1 types of data having the size of rd×rd are output.

The second convolutional layer 156 performs the convolution processing on the n+1 types of data having the size of rd×rd by a convolutional neural network to output resolution enhanced data that is enhanced in the resolution. A structure of the convolutional neural network is optional and is constructed by a plurality of iterated operations of convolution using a point-wise convolution as an example. The point-wise convolution means to convolve data corresponding to the same cell. As described above, by the integration layer 155 and the second convolutional layer 156, in the learning processing, the resolution enhanced data including the first auxiliary information weighted for each type of location integrated with the resolution enhanced intermediate data is output.

Hereinabove, the DNN constructed by the construction unit 150 is described.

The learning unit 160 learns the parameters for the DNN on the basis of the high-resolution data for learning, the low-resolution data for learning, the first auxiliary information for the types of locations, and the second auxiliary information, for each set of the area and the time zone. In the processing, first, the learning unit 160 uses the low-resolution data, the first auxiliary information, and the second auxiliary information as the inputs to the DNN model constructed in the construction unit 150, and acquires the resolution enhanced data, based on the output from the DNN model. The input to each layer of the DNN model in the learning processing of the learning unit 160 is as described above. The learning unit 160 learns the parameters for the DNN model to minimize an error between the resolution enhanced data output from the DNN model and the high-resolution data for learning. The processing by the learning unit 160 will be described below.

The learning unit 160 first initializes the parameters for the DNN model. Any initialization method may be used, and there is a method of inputting random values. Next, the high-resolution data for learning that is a correct answer is acquired for all ids from the demographics accumulation unit 110. The all ids correspond to all of the sets of the area and the time zone. The high-resolution data for learning is expressed as Yᵢ (i=1, N). The resolution enhanced data output from the DNN model is also acquired for all ids. The resolution enhanced data is expressed as F(Xᵢ) (i=1, N). Then, differences between the data are calculated. As an example of a method for calculating the difference, a mean squared error L expressed in Equation (3) below is determined.

$$\begin{matrix}[ Math . 3 ] & \\ L = \frac{1}{N} {\sum }_{i = 1}^{N} ‖ F ( {X}_{i} ) - {Y}_{i} ‖ & ( 3 )\end{matrix}$$

After the mean squared error L is determined, the parameters for the DNN model are optimized to minimize the mean squared error described above. An optimization method may be used, and as an example, a stochastic gradient descent method using normal backpropagation is used. The learning unit 160 stores the learned parameters for the DNN model in the DNN model accumulation unit 170. Note that the parameters for the DNN model that are learned by the learning unit 160 are not limited to the parameters for the neural network which are explicitly specified as being optimized in the above description of each layer, and parameters used for each layer are optimized.

The DNN model accumulation unit 170 stores therein the parameters for the DNN model learned by the learning unit 160.

Next, effects of the learning apparatus 100 will be described.

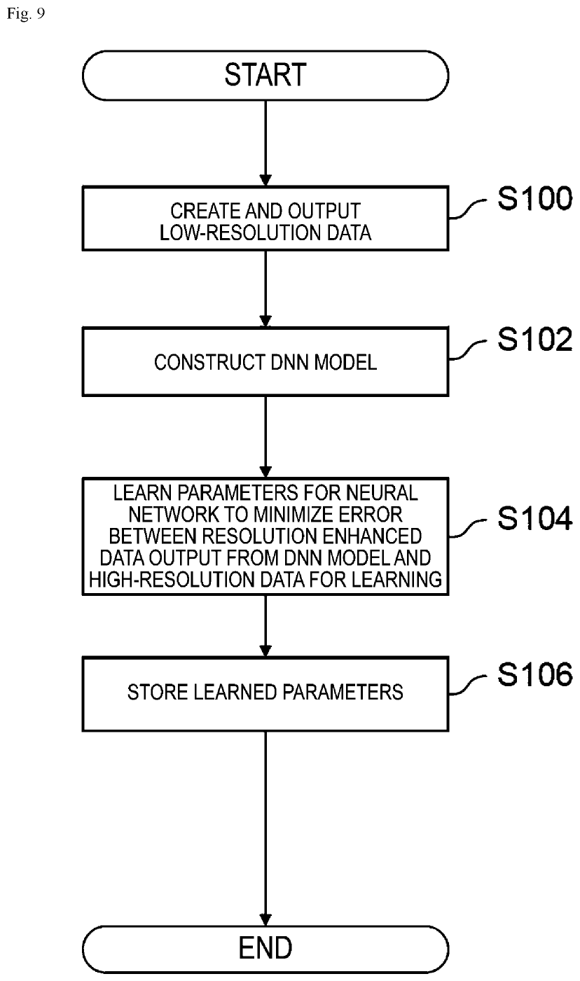

FIG. 9 is a flowchart illustrating a sequence of the learning processing performed by the learning apparatus 100. The CPU 11 reads the learning program from the ROM 12 or the storage 14, loads the learning program into the RAM 13, and executes the learning program, whereby the learning processing is performed.

In step S100, the CPU 11 acquires high-resolution data accumulated in the demographics accumulation unit 110, creates low-resolution data that is the high-resolution data whose resolution is reduced, and outputs the low-resolution data.

In step S102, the CPU 11 constructs the DNN model. The DNN model thus constructed includes the layers illustrated in the example in FIG. 7.

In step S104, the CPU 11 learns the parameters for the DNN model on the basis of the high-resolution data for learning, the low-resolution data for learning, the first auxiliary information for the types of locations, and the second auxiliary information, for each set of the area and the time zone. In the processing of step S104, first, the low-resolution data, the first auxiliary information, and the second auxiliary information are used as the inputs to the DNN model constructed in step S102, and the resolution enhanced data is acquired based on the output from the DNN model. Next, in accordance with Equation (3) described above, the parameters for the DNN model are learned to minimize an error between the resolution enhanced data output from the DNN model and the high-resolution data for learning.

In step S106, the CPU 11 stores the parameters for the DNN model learned in step S104, in the DNN model accumulation unit 170.

As described above, according to the learning apparatus 100 of the present embodiment, the parameters for the neural network for enhancing the resolution of the demographics can be learned to reflect the human behavioral patterns.

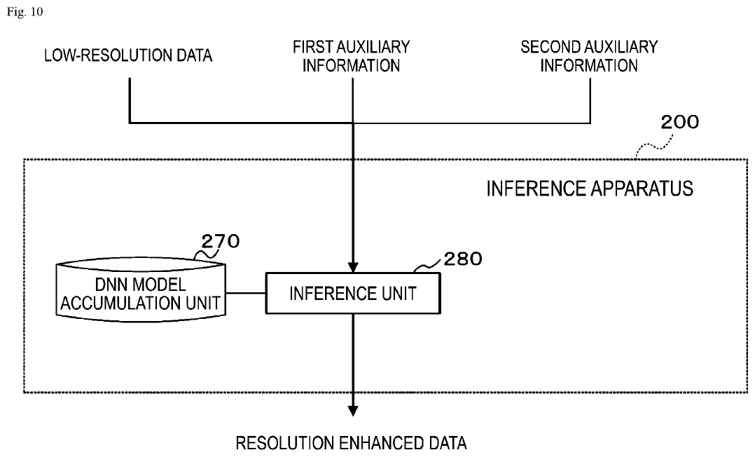

Configuration and Effect of Inference Apparatus FIG. 10 is a block diagram illustrating a configuration of an inference apparatus. As illustrated in FIG. 10, the inference apparatus 200 includes a DNN model accumulation unit 270 and an inference unit 280.

Note that the inference apparatus 200 can also be configured with a hardware configuration similar to that of the learning apparatus 100. As illustrated in FIG. 3, the inference apparatus 200 includes a CPU 21, a ROM 22, a RAM 23, a storage 24, an input unit 25, a display unit 26, and a communication I/F 27. The components are communicably interconnected through a bus 29. An inference program is stored in the ROM 22 or the storage 24.

Next, each functional configuration of the inference apparatus 200 will be described. Each functional configuration is implemented by the CPU 21 reading the inference program stored in the ROM 22 or the storage 24, and loading the inference program into the RAM 23 to execute the program.

The DNN model accumulation unit 270 stores therein the learned DNN model that has been learned in advance, which is a DNN model having the layers described above with reference to FIG. 7. For the learned DNN model, the parameters for the DNN model are learned by the learning apparatus 100 on the basis of the high-resolution data for learning, the low-resolution data for learning, the first auxiliary information for the types of locations, and the second auxiliary information, for each set of the area and the time zone. The layers of the learned DNN model include the first convolutional layer 151, the resolution enhancement layer 152, the weight calculation layer 153, the weighting layer 154, the integration layer 155, and the second convolutional layer 156. For the learned DNN model, the parameters are learned such that the low-resolution data, the first auxiliary information, and the second auxiliary information are used as the inputs to output the resolution enhanced data.

The inference unit 280 accepts the low-resolution data that is targeted to be enhanced in the resolution, and the first auxiliary information and the second auxiliary information for the target low-resolution data. The inference unit 280, when accepting these various pieces of target data, acquires the learned DNN model in the DNN model accumulation unit 270. The inference unit 280 inputs the target low-resolution data, and the first auxiliary information and the second auxiliary information for the target low-resolution data into the acquired learned DNN model, and outputs resolution enhanced data as an output from the learned DNN model.

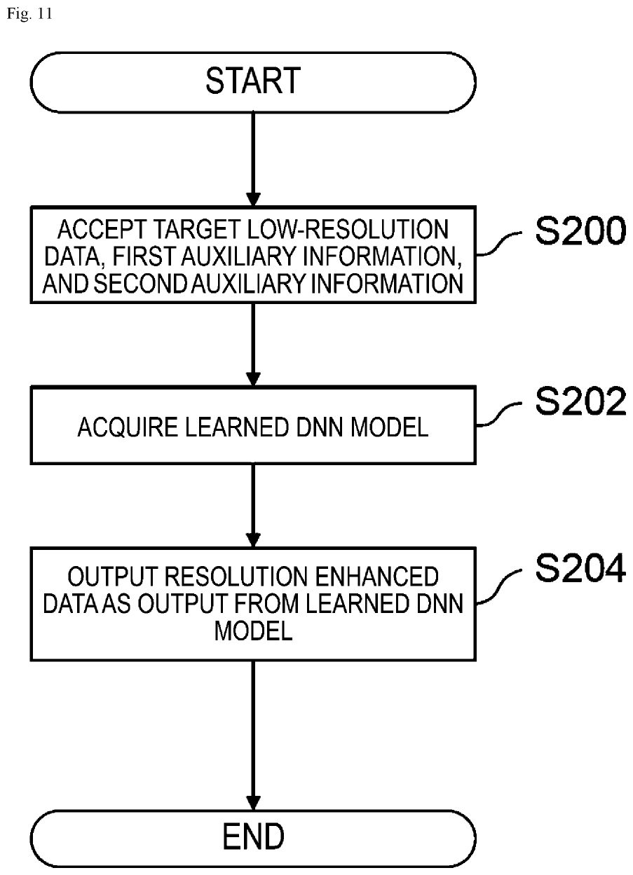

Next, effects of the inference apparatus 200 will be described. FIG. 11 is a flowchart illustrating a sequence of forecast processing performed by the inference apparatus 200. The CPU 21 reads the inference program from the ROM 22 or the storage 24, loads the inference program into the RAM 23, and executes the inference program, whereby the inference processing is performed.

In step S200, the CPU 21 accepts the low-resolution data that is targeted to be enhanced in the resolution, and the first auxiliary information and the second auxiliary information for the target low-resolution data.

In step S202, the CPU 21 acquires the learned DNN model from the DNN model accumulation unit 270.

In step S204, the CPU 21 inputs the target low-resolution data, and the first auxiliary information and the second auxiliary information for the target low-resolution data into the acquired learned DNN model, and outputs resolution enhanced data as an output from the learned DNN model.

As described above, according to the inference apparatus 200 of the present embodiment, the resolution of the demographics can be enhanced to reflect human behavioral patterns.

Note that, in each of the above-described embodiments, various processors other than the CPU may execute the learning processing or the inference processing in which the CPU executes by reading software (program). Examples of the processor in such a case include a programmable logic device (PLD) such as a field-programmable gate array (FPGA) of which circuit configuration can be changed after manufacturing, a dedicated electric circuit such as an application specific integrated circuit (ASIC) that is a processor having a circuit configuration designed dedicatedly for executing specific processing, and the like. The learning processing or the inference processing may be executed by one of such various processors or may be executed by a combination of two or more processors of the same type or different types (for example, a plurality of FPGAs, a combination of a CPU and an FPGA, or the like). More specifically, the hardware structure of such various processors is an electrical circuit acquired by combining circuit devices such as semiconductor devices.

In the embodiment described above, an aspect in which the learning program is stored (installed) in advance in the storage 14 has been described, but the present disclosure is not limited thereto. The program may be provided in the form of being stored in a non-transitory storage medium such as a compact disk read only memory (CD-ROM), a digital versatile disk read only memory (DVD-ROM), or a universal serial bus (USB) memory. The program may be in a form that is downloaded from an external device via a network. The inference program is also similar to the learning program.

With respect to the above embodiment, the following supplements are further disclosed.

Supplementary Note 1

A learning apparatus including

a memory, and
at least one processor connected to the memory,
the processor configured to,
in a neural network into which low-resolution data having a low resolution and representing demographics including positions and densities, first auxiliary information related to a type of location in an area and a position of the location, and second auxiliary information representing at least one of a time of day, weather, or another information representing a change in time series are input, and from which resolution enhanced data that is the demographics whose resolution being enhanced is output,
determine, based on the low-resolution data for learning for a set of an area and a time zone, resolution enhanced intermediate data that is the low-resolution data for the learning whose resolution being enhanced,
determine a weight for the type of location using the first auxiliary information for the type of location and the second auxiliary information, for the set of the area and the time zone, output resolution enhanced data including the first auxiliary information integrated with the resolution enhanced intermediate data, the first auxiliary information being weighted by the weight for the type of location, and
learn a parameter of the neural network, based on the resolution enhanced data output from the neural network and high-resolution data having a high resolution and representing the demographics for learning for the set of the area and the time zone.

Supplementary Note 2

A non-transitory recording medium recording a learning program, the learning program causing a computer to execute,

in a neural network into which low-resolution data having a low resolution and representing demographics including positions and densities, first auxiliary information related to a type of location in an area and a position of the location, and second auxiliary information representing at least one of a time of day, weather, or another information representing a change in time series are input, and from which resolution enhanced data that is the demographics whose resolution being enhanced is output,
determining, based on the low-resolution data for learning for a set of an area and a time zone, resolution enhanced intermediate data that is the low-resolution data for the learning whose resolution being enhanced,
determining a weight for the type of location using the first auxiliary information for the type of location and the second auxiliary information, for the set of the area and the time zone, outputting resolution enhanced data including the first auxiliary information integrated with the resolution enhanced intermediate data, the first auxiliary information being weighted by the weight for the type of location, and
learning a parameter of the neural network, based on the resolution enhanced data output from the neural network and high-resolution data having a high resolution and representing the demographics for learning for the set of the area and the time zone.

### REFERENCE SIGNS LIST

100 Learning apparatus
110 Demographics accumulation unit
120 First auxiliary information accumulation unit
130 Second auxiliary information accumulation unit
140 Resolution reduction unit
150 Construction unit
150A DNN model
151 First convolutional layer
152 Resolution enhancement layer
153 Weight calculation layer
154 Weighting layer
155 Integration layer
156 Second convolutional layer
160 Learning unit
170 Model accumulation unit
200 Inference apparatus
270 Model accumulation unit
280 Inference unit

1. A learning apparatus comprising circuitry configured to execute a method comprising:
in a neural network into which low-resolution data having a low resolution and representing demographics including positions and densities, first auxiliary information related to a type of location in an area and a position of the location, and second auxiliary information representing at least one of a time of day, weather, or another information representing a change in time series are input, and from which resolution enhanced data that is the demographics whose resolution being enhanced is output;
determining, based on the low-resolution data for learning for a set of an area and a time zone, resolution enhanced intermediate data that is the low-resolution data for the learning whose resolution being enhanced;
determining a weight for the type of location using the first auxiliary information for the type of location and the second auxiliary information, for the set of the area and the time zone;
outputting resolution enhanced data that is the first auxiliary information weighted by the weight for the type of location being integrated with the resolution enhanced intermediate data; and
learning a parameter of the neural network, based on the resolution enhanced data output from the neural network and high-resolution data having a high resolution and representing the demographics for learning for the set of the area and the time zone.

2. The learning apparatus according to claim 1,
wherein the neural network includes
a first convolutional layer configured to perform convolution processing on the low-resolution data for the learning,
a resolution enhancement layer configured to output the resolution enhanced intermediate data that is the low-resolution data subjected to the convolution processing whose resolution being enhanced to preserve an original density,
a weight calculation layer configured to calculate the weight for the type of location by a score function using a parameter to be learned, based on the first auxiliary information for the type of location and the second auxiliary information,
a weighting layer configured to output the first auxiliary information weighted by the weight for the type of location that is the first auxiliary information for the type of location being weighted by the weight for the type of location,
an integration layer configured to output data corresponding to the type of location, the data being the first auxiliary information weighted by the weight for the type of location being integrated with the resolution enhanced intermediate data, and
a second convolutional layer configured to perform convolution processing on the data corresponding to the type of location to output the resolution enhanced data, and
the circuit further configured to execute a method comprising:
learning a parameter of the neural network to minimize an error between the resolution enhanced data output from the neural network and the high-resolution data for learning.

3. (canceled)

4. A computer-implemented method for learning, comprising:
in a neural network into which low-resolution data having a low resolution and representing demographics including positions and densities, first auxiliary information related to a type of location in an area and a position of the location, and second auxiliary information representing at least one of a time of day, weather, and another information representing a change in time series are input, and from which resolution enhanced data that is the demographics whose resolution being enhanced is output,
determining, based on the low-resolution data for learning for a set of an area and a time zone, resolution enhanced intermediate data that is the low-resolution data for the learning whose resolution being enhanced;
determining a weight for the type of location using the first auxiliary information for the type of location and the second auxiliary information, for the set of the area and the time zone;
outputting resolution enhanced data that is the first auxiliary information weighted by the weight for the type of location being integrated with the resolution enhanced intermediate data; and
learning a parameter of the neural network, based on the resolution enhanced data output from the neural network and high-resolution data having a high resolution and representing the demographics for learning for the set of the area and the time zone.

5. The computer-implemented method according to claim 4,
wherein the neural network includes:
a first convolutional layer configured to perform convolution processing on the low-resolution data for the learning,
a resolution enhancement layer configured to output the resolution enhanced intermediate data that is the low-resolution data subjected to the convolution processing whose resolution being enhanced to preserve an original density,
a weight calculation layer configured to calculate the weight for the type of location by a score function using a parameter to be learned, based on the first auxiliary information for the type of location and the second auxiliary information,
a weighting layer configured to output the first auxiliary information weighted by the weight for the type of locations that is the first auxiliary information for the type of location being weighted by the weight for the type of location,
an integration layer configured to output data corresponding to the type of location, the data being the first auxiliary information weighted by the weight for the type of location being integrated with the resolution enhanced intermediate data, and
a second convolutional layer configured to perform convolution processing on the data corresponding to the type of location to output the resolution enhanced data, and
the learning includes learning the parameter of the neural network is learned to minimize an error between the resolution enhanced data output from the neural network and the high-resolution data for learning.

6. A computer-implemented method for learning, comprising:
inputting, into a neural network learned in advance to receive an input of low-resolution data having a low resolution and representing demographics including positions and densities, first auxiliary information related to a type of location in an area and a position of the location, and second auxiliary information representing at least one of a time of day, weather, or another information representing a change in time series and to output resolution enhanced data that is the demographics whose resolution being enhanced, the low-resolution data as a target, and the first auxiliary information and the second auxiliary information for the low-resolution data as the target; and
outputting, as an output from the neural network, the resolution enhanced data that is the demographics of the low-resolution data as the target whose resolution being enhanced,
wherein the neural network:
determines, based on the low-resolution data for learning for a set of an area and a time zone, resolution enhanced intermediate data that is the low-resolution data for the learning whose resolution being enhanced,
determines a weight for the type of location using the first auxiliary information for the type of location and the second auxiliary information, for the set of the area and the time zone, and
outputs resolution enhanced data that is the first auxiliary information weighted by the weight for the type of location being integrated with the resolution enhanced intermediate data, and
a parameter of the neural network is learned based on the resolution enhanced data output from the neural network and high-resolution data having a high resolution and representing the demographics for learning for the set of the area and the time zone.

7. (canceled)

8. The learning apparatus according to claim 1, wherein the neural network includes a combination of a deep neural network and a convolutional neural network.

9. The learning apparatus according to claim 1, wherein the demographics identifies data associated with a population.

10. The computer-implemented method according to claim 4, wherein the neural network includes a combination of a deep neural network and a convolutional neural network.

11. The computer-implemented method according to claim 4, wherein the demographics identifies data associated with a population.

12. The computer-implemented method according to claim 6, wherein the neural network includes a combination of a deep neural network and a convolutional neural network.

13. The computer-implemented method according to claim 6, wherein the demographics identifies data associated with a population.
